(19) United States
(12) Patent Application Publication
(10) Pub. No.: US 2009/0217604 A1
(43) Pub. Date: Sep. 3, 2009

(54) Mullion base plate extension

(76) Inventor: Victor Mamchych, Welland (CA)

Correspondence Address: VICTOR MAMCHYCH, 8875 SCHISLER RD., WELLAND, ON, L3B 5N4, CA

(21) Appl. No.: 12/072,657

(22) Filed: Feb. 28, 2008

(51) Int. Cl. E06B 3/00

(52) U.S. Cl. 52/208

(57) ABSTRACT

This invention relates to a base plate extension for a fire rated mullion that will firmly secure the base of the mullion in the event of a fire; to a low profile base plate; and, to a mullion assembly comprising a low profile base plate, a mullion latch, and a removable mullion in combination with a double door frame. A removable fire rated mullion is used in conjunction with double door openings to provide a securing point for rim panic bars mounted on doors. For a fire rating to be recognized it must comply with the standard, national Fire Protection Association Inc. (NFPA) 252 Fire Code. The (NFPA) 252 Fire Code was approved by the American National Standards Institute in 1995.

### BACKGROUND OF THIS INVENTION

In most commercial, industrial and institutional buildings, including schools, hospitals, hotels and similar types of structures, double doors hung in frames are used. In many cases these doors are latched to a center post, called a mullion; that allows the use of single doors in double door frames. In many instances the mullion is a removable hollow core tubular shape and can be removed to allow for large loads to be passed through the doors and then reinstalled.

Specific fire codes are applied to materials used in designated areas of public buildings, including door frames, doors, mullions and related hardware. To prevent a fire from drafting, NFPA 252 fire code requires that the doors be held shut for a specified length of time during a fire. National Fire Protection Association Inc. (NFPA) 252 Fire Code was approved by the American National Standards Institute in 1995. This fire code has been nullified by improper installations of some existing mullions. The base brackets presently used to engage and secure the mullion to the floor, significantly protrude, creating an upset hazard for wheeled vehicles such as wheel chairs.

Challenges arise with securing the top and bottom ends of the mullion because of its expansion and the violent abuse it undergoes during a fire. The systems that are currently employed pose two primary safety concerns; first, installation errors that void the fire rating and second, an upset hazard due to the high profile of the base plate which appears when the mullion is removed. The mullion holding systems currently in use employ sliding wedges, springs, in an array of mechanical assemblies that must be assembled on installation, providing room for error, loss of parts and fasteners. In some instances there have been mullions that have fallen out, an injury situation being created.

This application is an improvement in the inventions disclosed in my applications Ser. No. 08/666/139 filed Jun. 19, 1996, now U.S. Pat. No. 5,765,309 and my application Ser. No. 09/062/564 filed Apr. 20, 1998, now U.S. Pat. No. 5,941,023, which by reference here are made a part of the disclosure of this application.

### PRIOR ART

Various attempts have been made to overcome the problems associated with removing and reinstalling removable mullions and to make them fire rated.

U.S. Pat. No. 5,794,382 issued Apr. 18, 1998 to Prucinsky discloses a fire rated mullion using a fusible spacer mounted between two components of a group of components having overlapping joint with means for releasing clamping force when exposed to fire.

U.S. Pat. No. 5,890,319 issued Apr. 6, 1999 to Haeck et al discloses a removable mullion assembly including a spring loaded retaining bolt which locks the mullion in place. The locking mechanism is attached to the top fitting allowing the retaining bolt to be disengaged from the mullion. In the event of a fire a meltable platform within the top fitting releases a dead lock which mechanically blocks the retaining bolt from disengaging the mullion.

U.S. Pat. No. 7,000,355 issued Feb. 21, 2006 to Flory discloses a mullion arrangement for mounting a door frame including a top fitting secured to an upper frame member or header of the door frame, bottom fitting secured to the floor beneath the top fitting, and a mullion removably positioned between the top and bottom fittings. The mullion defines a cavity which carries cabling to an electric strike for regulating opening of the door.

Although these patents address the problem of providing removable mullions, they have many disadvantages as will become apparent hereinafter. Furthermore, none of them show the simple, durable, easy to use and maintain, inexpensive base plate extension for a fire rated mullion that will firmly secure the mullion to the base plate in the event of a fire; or to a low profile base plate adapted to securely receive the base plate extension during a fire; or to a mullion assembly which is fire rated comprising a mullion latch, said base plate and a removable mullion in combination with a double door frame which is friendly to the user and allows for easy and rapid removal and reinstallation of removable mullions.

### OBJECTS OF THIS INVENTION

It is an object of this invention to provide a base plate extension for a fire rated removable thumb release mullion that will provide for a low profile base plate on the floor, thereby eliminating the upset hazard inherent in the use of high profile base plates, where said high profile is necessary to help secure the mullion during a fire. Further, in the event of a fire this invention permanently stops the mullion from jumping off its seat.

It is also an object of this invention to provide a low profile base plate that does not require fasteners to manually secure the mullion to the base plate.

It is further the object of this invention to provide a mullion assembly that is easy to install without nullifing the fire rating by an incorrect installation.

It is another object of this invention to provide a means of suspending the base plate extension in the core of a mullion at a predetermined distance above a receiver slot in the base plate thereby allowing for its secure engagement and alignment in the receiver slot by using the vertical characteristics of the mullion.

It is also an object of this invention to use a certified temperature rated fusible link to release the base plate extension at a predetermined temperature.

It is still further an object of this invention to use a reverse directional tensioning system to secure the base plate extension inside the mullion at a predetermined height.

It is another object of this invention to provide a fire rated mullion assembly with a removable mullion, said assembly including the means for accomplishing the forgoing objects.

### SUMMARY OF THE INVENTION

These and other objects are accomplished by my invention which comprises a base plate extension having a top, a bottom and two side edges; a plate adapted to fit into the core of a mullion; means to secure said plate in the core and above the bottom end of the mullion; a low profile base plate adapted to receive and secure the bottom end of the mullion, and, having a slot or opening to receive the bottom of the base plate extension; means to cause the release of said base plate extension to fall or drop into a receiver slot or opening in the low profile base plate, thereby securing and stabilizing the position of the mullion during a fire when installed in a double door frame.

Also my invention comprises a low profile base plate adapted to receive and securely engage a removable mullion comprising a rectangular base plate adapted to secure and align a mullion, said base plate having a slot or opening adapted to receive a base plate extension which is secured in the core of the mullion and released during a fire when installed in a double door frame.

My invention also comprises a mullion assembly comprising a base plate extension; a low profile base plate; and a removable mullion having a mullion latch in combination with a door frame; said base plate extension having means for being secured in the core of the mullion comprising a reverse directional tension system and a fusible link connected to the base plate extension; said low profile base plate adapted to receive and securely engage the removable mullion, and having a slot or opening adapted to receive and secure the base plate extension when released during a fire; said mullion latch having a housing, means to secure it to the door frame header, and a latch with a lever used for installing and removing the mullion.

This invention will become apparent from the description and accompanying drawings, which illustrate preferred embodiments of this invention. A brief description of the Drawings or Figures follows.

### THE FIGURES

FIG. 1 illustrates an elevation view of a double doorway viewed from the inside having swinging doors in closed position, mounted within a metal frame, with a removable mullion between doors having locking and opening mechanisms such as panic rim hardware.

FIG. 2 is an expanded elevation view from the inside of the doors, showing the latch housing secured to the top frame or header of the double door frame.

FIG. 3 is an expanded elevation view from inside of the doors, showing the base plate and its retaining protrusions for engaging the mullion in a vertical position.

FIG. 4 is an isometric drawing of a lower portion of a removable mullion with cut outs to better illustrate the reverse directional tensioning system, the fusible link, and the alignment of the base plate extension with the receiver slot in the base plate.

FIG. 5 is a side elevation illustrating a lower portion of a removable mullion installed on a base plate with the protrusions securing the mullion in tight alignment. A receiver slot has been provided in the base plate that will accept the base plate extension. The base plate extension is attached to the bottom of a fusible link that is suspended from two reverse arched springs,(i.e. reverse directional tensioning system), secured back to back and tension held within the mullion between its opposite inside troughs.

FIG. 6 is a plan elevation of the base plate illustrating the holes provided for fasteners to secure the base plate to the floor. Further, illustrated are the contact points around the perimeter that engage the mullion. This illustration clearly shows the diagonally intersecting receiver slots for the base plate extension.

FIG. 7 is a side elevation illustrating a removable mullion mounted on a base plate, with the base plate extension engaged inside the receiver slot, which is provided within the base plate. The base plate extension has been released at a set temperature caused by a fire. The engagement between the released base plate extension within the receiver slot secures the mullion. The base plate protrusions have now been increased to include the length of the base plate extension, thus it is not possible for the mullion to disengage from the base plate.

### A BRIEF DESCRIPTION OF THE INVENTION

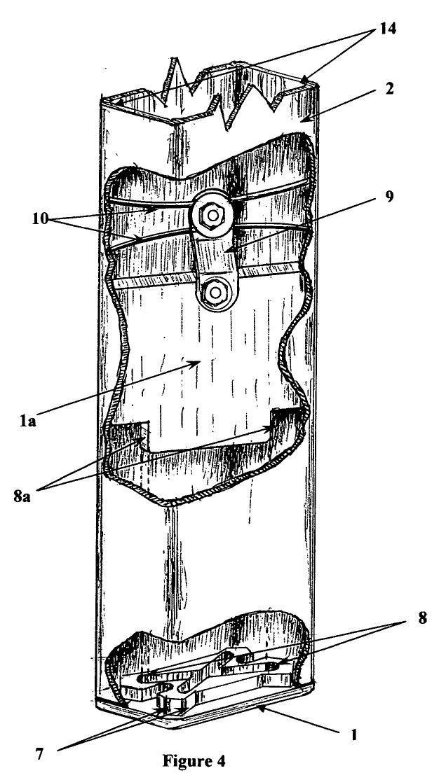

The following Brief Description of the Invention is best understood with reference to FIG. 4.

In the event of a fire, this system will increase the length of engagement between the base plate, 1, and the mullion, 2, making it impossible for the mullion, 2, to disengage from the base plate, 1.

In the event of a fire, the base plate extension, la, that is hung from a reversed directional tensioning system, comprising a pair of reverse arched springs, 10, that are secured to the top end of a certified fusible link, 9, the base plate extension, la, is secured to the bottom end of the certified fusible link, 9. When a specific temperature is reached during a fire, the certified fusible link, 9, will separate allowing the base plate extension, la, to drop and engage with the receiver slot in the base plate, 1, securing the mullion, 2, permanently in place.

### DETAILED DESCRIPTION OF THE INVENTION

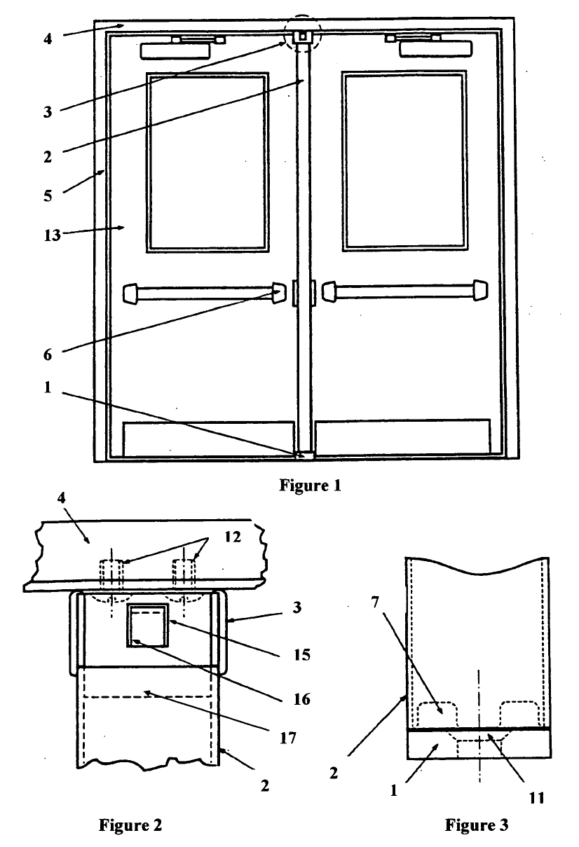

Referring to FIGS. 1 through 7:

FIG. 1 illustrates an elevation view of a double doorway viewed from the inside, having doors, 13, mounted within a door frame, with header, 4, door frame jams, 5, doors, 13, fitted with rim panic hardware, 6, and showing the removable mullion, 2, between the doors fitted onto a base plate, 1, over its protrusions, 7, and locked in place at the top by the mullion latch and housing, 3, therefore securing the mullion, 2, at the top and bottom of the door frame. The latch housing, 3, is a thumb release device as described in my U.S. Pat. No. 5,765,309, which allows for easy removal of a mullion without tools.

FIG. 2 illustrates an expanded elevation view from the inside of the doors, 13, showing the mullion latch housing, 3, secured to the doorframe header, 4, with bolts, 12, the opening for the thumb lever in the rear leg of the housing, 15, that allows the thumb lever, 16, to protrude to the outside, so it can be depressed to release the mullion, 2. There is a provision in the latch housing, 3, that allows for the mullion, 2, to expand in its length during a fire. The opening of the housing that allows for expansion maybe left as unfinished or may be covered by a mullion replica, not shown, to give the impression of a mullion. This cover has no structural purpose; therefore it can be made of any material that will disintegrate in a fire. Alternatively, a metal insert fitting on the outside of the mullion may be employed, thereby allowing the expanding mullion to telescope into the inside of the metal insert during a fire.

FIG. 3 illustrates an expanded elevation view from inside the doors, 13, showing the base plate, 1, and the retaining protrusions, 7. During normal operation of the removable mullion, 2, the protrusions, 7, which protrude approximately 3/8″ providing adequate engagement to hold the mullion, 2. In the event of a fire, the mullion, 2, may be exposed to severe drafts or wind gusts which could pull the mullion, 2, off the seat or protrusions, 7, causing the doors to open. The base plate, 1, is secured to the floor with lag bolts and shields or comparable means (not shown in FIG. 3).

FIG. 4 is an isometric drawing with cut outs to better illustrate the reverse arched springs, 10, the certified fusible link, 9, and the alignment of the base plate extension, 1 a, with the base plate receiver slot, 8, in the base plate, 1.

FIG. 5 illustrates a side elevation view of the mullion, 2, mounted on the base plate, 1, with the protrusions, 7, inside the bottom of the mullion, 2. The base plate, 1, has been provided with two diagonal receiver slots, 8a, to prevent the installer from making the mistake of reversing it, therefore the base plate extension, 1a, will line up with the receiver slot, 8, even if the base plate extension, 1a, itself is reversed in its diagonal mounting in the mullion, 2, the base plate extension, 1a, which is made to fit diagonally inside the mullion, 2, and free enough as not to impede its travel down the mullion, 2, in the event of a fire, the length of the base plate extension, 1a, prevents the base plate extension, 1a, from wobbling inside the mullion, 2. The base plate extension, 1a is secured to one end of a certified fusible link, 9, which has a set melting point; the other end of this certified fusible link is secured to a pair of reverse arched springs, 10, coupled back to back and tensioned inside the mullion, 2, and between the two opposite troughs, 14, FIG. 4. With the weight of the base plate extension, 1a, pulling down on the reverse arched springs, 10, the load is being applied to the arch of the lower spring, the ends of which are tensioned into the sides of the mullion, 2, the more pressure that is applied, the more the spring will tension; the reverse would apply to the top spring.

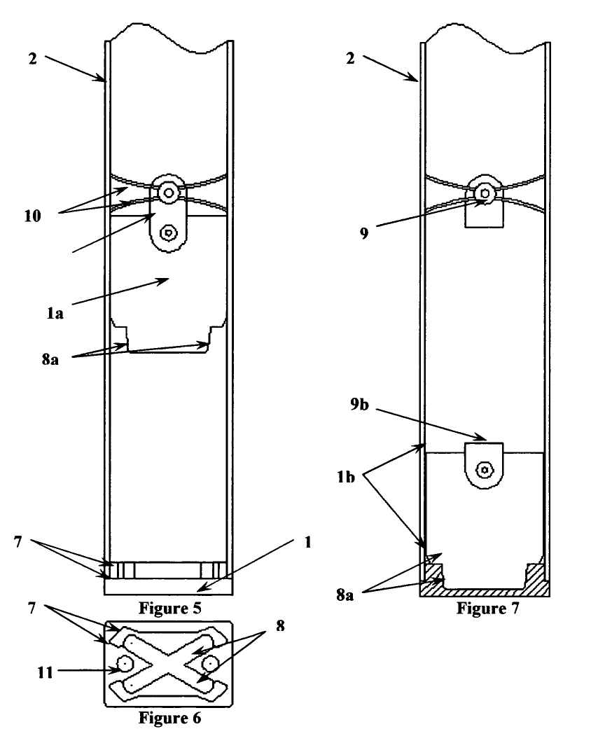

FIG. 6 is a plan elevation of the base plate, 1, illustrating the diagonal receiver slots, 8a, for the base plate extension, 1a, also shown are the bolt holes, 11, used to secure the base plate, 1, to the floor. The contact points on protrusions, 7, are clearly visible.

FIG. 7 illustrates the base plate extension, 1a, in the dropped position where it is engaged with the base plate, 1, via the receiver slot, 8, Now the base plate, 1, and the base plate extension, 1a, are unified as one part, and engage the mullion, 2, at, 1b, by approximately 3″ making the combination totally secure, even if the mullion, 2, was to rise above the base plate protrusion, 7, the mullion, 2, is still held secure by the engagement portion, 1b, of the base plate extension, 1a. The mullion, 2, has now become a non removable mullion.

### EXAMPLE

The fire rated mullion is simply installed within a double door frame as shown in FIG. 1. The latch housing, 3, is secured by fastening means, to the door frame header, 4, and is centered at the point where the double doors meet. The base plate, 1, is fastened to the floor and is also centered to where the double doors meet, and is aligned flush with the doors. The mullion, 2, with the base plate extension, 1a, which is firmly secured inside the core of the mullion, approximately two feet above the floor by using reverse arched springs, 10, thereby holding the base plate extension, 1a, in place during the handling and cutting the mullion, 2, to length,. The mullion, 2, is inserted over the bottom of the rear leg of housing, 17, indicated by hidden line in FIG. 2, of the latch housing, 3. The bottom end of the mullion, 2, is guided over the protrusions, 7, FIG. 3, on the base plate, 1. Now the top of the mullion, 2, is simply pushed ahead into place and is locked in by the latch within the housing, 3.

For removal of the mullion, 2, the thumb latch lever, 16, is depressed and the mullion is pulled back and lifted out, the base plate extension, 1a, FIG. 4, is not disturbed during normal operation of the mullion, 2.

During a fire the base plate extension, 1a, which is secured to the reverse arched springs, 10, via a certified fusible link, 9, FIGS. 4 and 5; when this link reaches a specified temperature it separates allowing the base plate extension, 1a, to fall and engage within the diagonal slot in the base plate, 1, FIG. 7; thereby increasing the engagement the base plate extension and the base plate from ⅜ of an inch to 3 inches, during a fire, thus the mullion, 2, is now unable to become disengaged. The low profile base plate, 1, FIG. 5, during normal operation is ⅝ inches off the floor which includes the protrusions, 7. This height avoids conditions for upsetting wheel chairs, avoids tripping hazard and provides lower undercarriage clearance for moving machinery through the widened doorway opening.

### Modifications

Although the foregoing description, discloses the use of a reverse directional tension system such as reversed arched springs mounted back to back and tension held inside the core of a mullion at a given height from the bottom end of the mullion, various means other than such inversed tension means maybe employed, such as adhesives, threaded fasteners, and the like. The holding devices that hold the certified fusible link and the reversed arched springs together maybe bolted, riveted, fused, crimped, or molded. I have found that positioning of the base plate extension in the core of the mullion by securing it about two feet from the bottom end of the mullion is satisfactory for performance to meet the NFPA 252 Fire Code, however other positions may be employed. All that is required in accordance with my invention is that the base plate extension be secured in place in the core of the mullion so that the mullion may be handled and worked on, such as during installation, and remain in ready position high enough in the core to drop into the base plate receiver opening when the fusible link is melted, providing the means for releasing the base plate extension during a fire so that it may be securely engaged in the receiver opening in the base plate thereby securing the mullion when in the upright position.

The means for releasing the base plate extension consists of a material that will bind together the reverse arched springs to the base plate extension and melt by the heat of a fire, thereby causing the base plate extension to drop into the receiver slot. Certified fusible link material is used in accordance with my invention for fire rated installations; that is, a fusible link certified to melt at a given temperature during a fire. For example, certified fusible link material is composed of two metal strips, such as tin bonded by solder, epoxy resin, and the like which melt at a predetermined temperature. Alternatively, other materials such as plastic, nylon and the like may be utilized provided they have the predetermined melting temperature characteristics. Thus, in accordance with my invention the only requirement of the certified fusible link is that it binds the reversed directional tensioning system to the base plate extension and that it melts at a predetermined temperature.

The base plate extension can vary in shape and size and thickness, the preferred parameters are that the width from side to side is just loose enough to permit the base plate extension to travel freely and yet be guided into the receiver slot in the base plate during a fire. The weight and thickness should be heavy enough so as not to bend or distort if the mullion was to jump off its seat on the base plate during a fire. The height from top to bottom of the base plate extension should be sufficient to prevent the base plate extension from wobbling during decent into the receiving slot or opening in the base plate during a fire.

The low profile base plate receiver slot in the preferred embodiment is shown as, 8, in FIG. 4 and in FIG. 6, however, variations in design are also applicable in my invention. For example, instead of raised protrusions, jut outs, projections and the like may be designed to provide the receiver slots for securing the base plate extension when dropped in a fire. Furthermore, the receiver slots may be provided in a flat surfaced base plate and all that is required in accordance with my invention is to maintain a low profile base plate of about ⅝ inch thickness in order to avoid a hazardous condition when objects are moved through the widened open doors. The receiver slots or openings may be varied from the diagonal slots shown in FIGS. 4 and 6. For example, round holes, key holes and various other designs of apertures, depressions, grooves or notches may be employed just as long as the bottom edge of the base plate extension is designed to fit into the receiver slots to secure and stabilize the position of the mullion during a fire when installed in a double door frame. Even though a flat plate is described in the above description, any shape that will hold the mullion in direct alignment to prevent torsional twisting may be employed.

The mullion replica insert or sleeve, may be in one mode, be made of any material that is friable, shatter able or crush able under the pressure generated when the mullion expands, thereby allowing space for the expansion and maintaining the integrity of the mullion. For example, glass, ceramic, foamed or sintered metal and other substances that can be shaped to replicate the mullion may be used. In another mode, the mullion replica insert or sleeve, may be made of materials that are fusible and displaced during a fire, such as plastics, composite of fusible materials and the like, thereby providing space for expansion of the mullion during a fire. The mullion replica sleeve is ornamental, not necessary for a fire rating and therefore not a utility part.

The mullion assembly in the preferred mode of my invention is composed of parts made of steel which is commonly used in most installations of double door mullion passage ways. Other metals and various grades of steel, such as stainless steel or even titanium and the like that have similar heat resistant properties during a fire may be employed. In the foregoing description I have described a removable mullion with a thumb latch release, however, other mechanism for removing the mullion may be used in combination with the base plate extension and/or low profile base plate of my invention.

I have exemplified my invention using preferred embodiments, it is to be understood that departure may be made there from within the scope of my invention, which is not to be limited to the details disclosed herein, but is to be accorded the full scope of the appended claims so as to embrace all equivalents.

1- A base plate extension having a top, a bottom and two side edges comprising; a plate adapted to fit into the core of a mullion; means to secure said plate in the core and above the bottom end of the mullion; a low profile base plate adapted to receive and secure the bottom end of a mullion, and, having a slot or opening to receive the bottom of the base plate extension; means to cause the release of said base plate extension to fall into a slot or opening in the low profile base plate, thereby securing and stabilizing the position of the mullion during a fire when installed in a double door frame.

2- A base plate extension in accordance with claim 1 wherein said plate is made of steel.

3- A base plate extension in accordance with claim 1 wherein the means to secure the plate in the core of the mullion comprises a reverse directional tension system.

4- A base plate extension in accordance with claim 3 wherein the reverse directional tension system comprises reverse arched springs.

5- A base plate extension in accordance with claim 1 wherein the base plate extension is oriented in a diagonal position in the core of a rectangular mullion.

6- A base plate extension in accordance with claim 1 wherein the means to cause the release of said base plate extension to fall during a fire is a certified fusible link binding the reverse directional tension system and the base plate extension.

7- A low profile base plate adapted to receive and securely engage a removable mullion comprising a rectangular base plate adapted to secure and align a mullion, said base plate having a slot or opening adapted to receive a base plate extension which is secured in the core of the mullion and released during a fire when installed in a double door frame.

8- A low profile base plate in accordance with claim 7 wherein there are two diagonal slots or openings, each of a depth to receive and secure a base plate extension when released during a fire, said slots of openings extending from the corners of the base plate.

9- A mullion assembly comprising a base plate extension; a low profile base plate; and a removable mullion having a mullion latch in combination with a door frame; said base plate extension having means for being secured in the core of the mullion comprising a reverse directional tension system and a fusible link connected to the base plate extension; said low profile base plate adapted to receive and securely engage the removable mullion, and having a slot or opening adapted to receive and secure the base plate extension when released during a fire; said mullion latch having a housing, means to secure it to the door frame header, and a latch with a lever used for installing and removing the mullion.

10- A mullion assembly in accordance with claim 9 wherein the length of the mullion is sized to create an expansion opening to accommodate any expansion of the mullion during a fire, thereby maintaining the integrity of the mullion in the upright position.

11- A mullion assembly in accordance with claim 10 wherein the expansion opening is fitted with a mullion replica insert or sleeve shaped to cover and obscure the expansion opening.

12- A mullion assembly in accordance with claim 11 wherein the mullion replica insert or sleeve is made of friable, shatter able or crush able material.

13- A mullion assembly in accordance with claim 9 wherein the base plate extension has a certified fusible link connecting the reverse directional tension system and the base plate extension.

14- A mullion assembly in accordance with claim 9 wherein the core of the mullion contains a base plate extension having reverse arched springs, said mullion having an expansion opening to accommodate any expansion of the mullion during a fire, and a certified fusible link binding said springs with the base plate extension, said assembly being made of steel.

15- A mullion assembly in accordance with claim 14 wherein the mullion assembly is fire rated.
